(19) United States
(12) Patent Application Publication
(10) Pub. No.: US 2021/0276531 A1
(43) Pub. Date: Sep. 9, 2021

(54) VEHICLE POWER MANAGEMENT SYSTEM AND METHOD

(71) Applicant: The University of Birmingham, Birmingham (GB)

(72) Inventors: Hongming Xu, Birmingham (GB); Quan Zhou, Birmingham (GB)

(21) Appl. No.: 17/255,484

(22) PCT Filed: Jun. 20, 2019
(86) PCT No.: PCT/GB2019/051729

§ 371 Date: Dec. 23, 2020

(30) Foreign Application Priority Data
Jun. 29, 2018 (GB) 1810755.7

(51) Int. Cl. B60W 20/10; B60W 20/20; B60L 1/00

(52) U.S. Cl. CPC B60W 20/10; B60L 1/00; B60W 20/20

(57) ABSTRACT

A vehicle power management system (100) for optimising power efficiency in a vehicle (400), by managing a power distribution between a first power source (410) and a second power source (420). A receiver (110) receives a plurality of samples from the vehicle (400), each sample comprising vehicle state data, a power distribution and reward data measured at a respective point in time. A data store (350) stores estimated merit function values for a plurality of power distributions. A control system (200) selects, from the data store (350), a power distribution having the highest merit function value for the vehicle state data at a current time, and transmits the selected power distribution to be implemented at the vehicle (400). A learning system (300) updates the estimated merit function values in the data store (350), based on the plurality of samples.

### FIELD OF INVENTION

The invention relates to systems and methods of power management in hybrid vehicles.

In particular, but not exclusively, the invention may relate to a vehicle power management system for optimising power efficiency by managing the power distribution between power sources of a hybrid vehicle.

### BACKGROUND

There is an increasing demand for hybrid vehicles as a result of rising concerns about the impact of vehicle fuel consumption and emissions. A hybrid vehicle comprises a plurality of power sources to provide motive power to the vehicle. One of these power sources may be an internal combustion engine using petroleum, diesel, or other fuel type. Another of the power sources may be a power source other than an internal combustion engine, such as an electric motor. Any of the power sources may provide some, or all, of the motive power required by the vehicle at a particular point in time. Hybrid vehicles thus offer a solution to concerns about vehicle emissions and fuel consumption by obtaining part of the required power from a power source other than an internal combustion engine.

Each of the power sources provides motive power to the vehicle in accordance with a power distribution. The power distribution may be expressed as a proportion of the total motive power requirement of the vehicle that is provided by each power source. For example, the power distribution may specify that 100% of the vehicle's motive power is provided by an electric motor. As another example, the power distribution may specify that 20% of the vehicle's motive power is provided by the electric motor, and 80% of the vehicle's motive power is provided by an internal combustion engine. The power distribution varies over time, depending upon the operating conditions of the vehicle.

A component of a hybrid vehicle known as a power management system (also known as an energy management system) is responsible for determining the power distribution. Power management systems play an important role in hybrid vehicle performance, and efforts have been made to determine the optimal power distribution to satisfy the motive power requirements of the vehicle, while minimising emissions and maximising energy efficiency.

Existing power management methods can be roughly classified as rule-based methods and/or optimisation-based methods. One optimisation-based method is Model-based Predictive Control (MPC). In this method, a model is created to predict which power distribution leads to the best vehicle performance, and this model is then used to determine the power distribution to be used by the vehicle. Several factors may influence the performance of MPC, including the accuracy of predictions of future power demand, which algorithm is used for optimisation, and the length of the predictive time interval. As these factors include predicted elements, the resulting model is often based on inaccurate information, negatively affecting its performance. The determination and calculation of a predictive model requires a large amount of computing power, with an increased length of predictive time interval generally leading to better results but longer computing times. Determining well-performing models is therefore time-consuming, making it difficult to apply in real-time. MPC methods include a trade-off between optimisation and time, as decreasing the complexity of model calculation to decrease calculation time leads to coarser model predictions.

Using a non-predictive power management method, for example determining the power distribution based only on the current state of the vehicle, removes the requirement for large amounts of computing power and lengthy calculation times. However, non-predictive methods do not consider whether the determined power distributions lead to optimal vehicle performance over time.

### SUMMARY

According to an aspect of the invention, there is provided a vehicle power management system for optimising power efficiency in a vehicle comprising a first power source and a second power source, by managing a power distribution between the first power source and second power source, the vehicle power management system comprising: a receiver configured to receive a plurality of samples from the vehicle, each sample comprising vehicle state data, a power distribution and reward data measured at a respective point in time; a data store configured to store estimated merit function values for a plurality of power distributions; a control system configured to select, from the data store, a power distribution having the highest merit function value for the vehicle state data at a current time, and transmit the selected power distribution to be implemented at the vehicle; and a learning system configured to update the estimated merit function values in the data store, based on the plurality of samples, each measured at a different point in time.

Optionally, the vehicle state data comprises required power for the vehicle.

Optionally, the first power source is an electric motor configured to receive power from a battery.

Optionally, the vehicle state data further comprises state of charge data of the battery.

Optionally, the learning system of the vehicle power management system is configured to update the estimated merit function values in the data store based on samples taken during the time period between the current update and the most recent preceding update.

Optionally, the learning system and the control system are separated on different machines.

Optionally, the learning system is configured to update the estimated merit function values in the data store using a predictive recursive algorithm.

Optionally, the learning system is configured to update the estimated merit function values in the data store according to a recurrent-to-terminal, R2T, algorithm.

Optionally, the control system is configured to generate a random real number between 0 and 1; compare the randomly generated number to a pre-determined threshold value; and if the random number is smaller than the threshold value, generate a random power distribution; or if the random number is equal to or greater than the threshold value, select, from the data store, a power distribution having the highest merit function value for the vehicle state data at a current time.

According to another aspect of the invention there is provided a method for optimising power efficiency in a vehicle comprising a first power source and a second power source, by managing a power distribution between the first power source and the second power source, the method comprising the following steps: receiving, by a receiver, a plurality of samples from a vehicle, each sample comprising vehicle state data, a power distribution and reward data measured at a respective point in time; storing, in a data store, estimated merit function values for a plurality of power distributions; selecting, by a control system, a power distribution from the data store having the highest merit function value for the vehicle state data at a current time; and updating, by a learning system, the estimated merit function values in the data store, based on the plurality of samples, each measured at a different point in time.

Optionally, the vehicle state data received by the receiver comprises required power for the vehicle.

Optionally, the first power source is an electric motor receiving power from a battery.

Optionally, the vehicle state data further comprises state of charge data of the battery.

Optionally, the learning system updates the estimated merit function values based on samples taken during the time period between the current update and the most recent preceding update.

Optionally, the method steps performed by the learning system are performed on a different machine to the method steps performed by the control system.

Optionally, the method further comprises updating the estimated merit function values, by the learning system, comprises updating the estimated merit function values using a predictive recursive algorithm.

Optionally, the method further comprises updating, by the learning system, the estimated merit function values in the data store according to a recurrent-to-terminal, R2T, algorithm.

Optionally, the method further comprises, generating, by the control system, a real number between 0 and 1; comparing the randomly generated number to a pre-determined threshold value; and if the random number is smaller than the pre-determined threshold value, generating, by the control system a random power distribution; or if the random number is equal to or greater than the threshold value, select, by the control system, from the data store, a power distribution having the highest merit function value for the vehicle state data at a current time.

According to another aspect of the invention, there is provided a processor-readable medium storing instructions that, when executed by a computer, cause it to perform the steps of a method as described above.

### BRIEF DESCRIPTION OF THE DRAWINGS

Exemplary embodiments of the invention are described herein with reference to the accompanying drawings, in which:

FIG. 1 is a schematic representation of a vehicle power management system in accordance with the present invention;

FIG. 2 is a schematic representation of a control system of a vehicle power management system in accordance with the present invention;

FIG. 3 is a schematic representation of a learning system of a vehicle power management system in accordance with the present invention;

FIG. 4 is a schematic representation illustrating estimated merit function values in a data store in accordance with the present invention;

FIG. 5 is a flowchart showing the steps of a learning system updating estimated merit function values in accordance with the present invention;

FIG. 6 is a flowchart showing the steps of a distribution selection by a control system in accordance with the present invention;

FIG. 7a shows three graphs of achieved system efficiency of a vehicle as a function of the learning time, for different numbers of samples in an update set, for the S2T, A2N, and R2T algorithms described hereinbelow; and

FIG. 7b is a graph of achieved system efficiency of a vehicle as a function of the learning time for different values of discount factor λ, in the R2T algorithm.

### DETAILED DESCRIPTION

Generally disclosed herein are vehicle power management systems and methods for optimising power efficiency in a vehicle comprising multiple power sources, by managing the power distribution between these power sources. The vehicle is a hybrid vehicle comprising two or more power sources. Motive power is provided to the vehicle by at least one of the power sources, and preferably by a combination of the power sources, wherein different sources may provide different proportions of the total required power to the vehicle at any one moment in time. The sum of the proportions may amount to more than 100% of the motive power, if other power requirements are also placed on one or more of the power sources, for example, charging of a vehicle battery by an internal combustion engine. Many different power distributions are possible, and data obtained from the vehicle may be used to determine which power distributions result in better vehicle efficiency for particular vehicle states and power requirements.

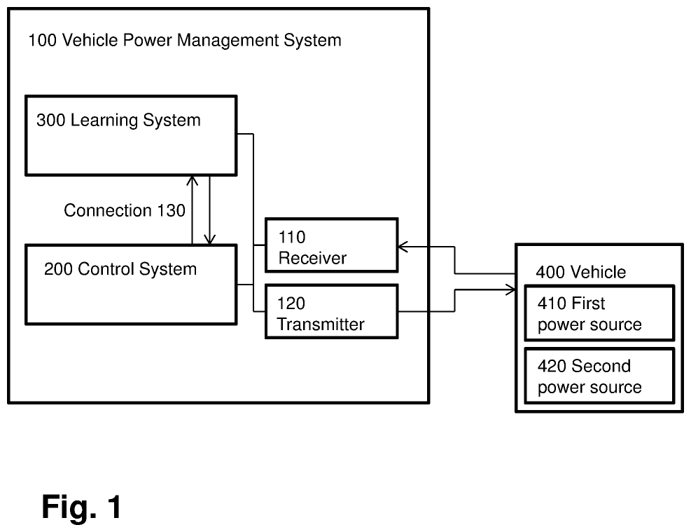

FIG. 1 shows a schematic representation of a vehicle power management system 100 according to an aspect of the invention. The vehicle power management system 100 comprises a receiver 110 and a transmitter 120 for receiving and transmitting information from and to the external environment, for example to a vehicle 400. The vehicle is a hybrid vehicle comprising a first power source 410, and a second power source 420. One of the power sources may be an internal combustion engine using a fuel, for example petroleum or diesel. The other of the power sources may be an electric motor.

The vehicle may optionally further comprise any number of additional power sources (not shown in FIG. 1). The vehicle 400 may further comprise an energy storage device (not shown in FIG. 1), such as one or more batteries or a fuel cell. The vehicle may be configured to generate energy (e.g. by means of an internal combustion engine and/or regenerative braking), to store the generated energy in the energy storage device, and to use the stored energy to provide power to one of the power sources (e.g. by providing electrical power stored in a battery to an electric motor). The vehicle power management system 100 further comprises a control system 200 for selecting and controlling power distributions for vehicle 400, and a learning system 300 for estimating merit function values in relation to vehicle states and power distributions. As used herein the term merit function value is a value related to the efficiency of the vehicle power management system. The merit function value may be related to the vehicle efficiency. The merit function value may further relate to additional and/or alternative objectives relating to vehicle power management optimisation. As used herein, the term merit function is used to describe a mathematical function, algorithm, or other suitable means that is configured to optimise one or more objectives. The objectives may include, but are not limited to, vehicle power efficiency, battery level (also known as the state of charge of a battery), maintenance, fuel consumption by a fuel-powered engine power source, efficiency of one or more of the first and second power source, etc. The merit function results in a value, referred to herein as the merit function value, which represents the extent to which the objectives are optimised. The merit function value is used as a technical indication of the efficiency and benefit of selecting a power distribution, for a given vehicle state. Control system 200 and learning system 300 are connected via a connection 130.

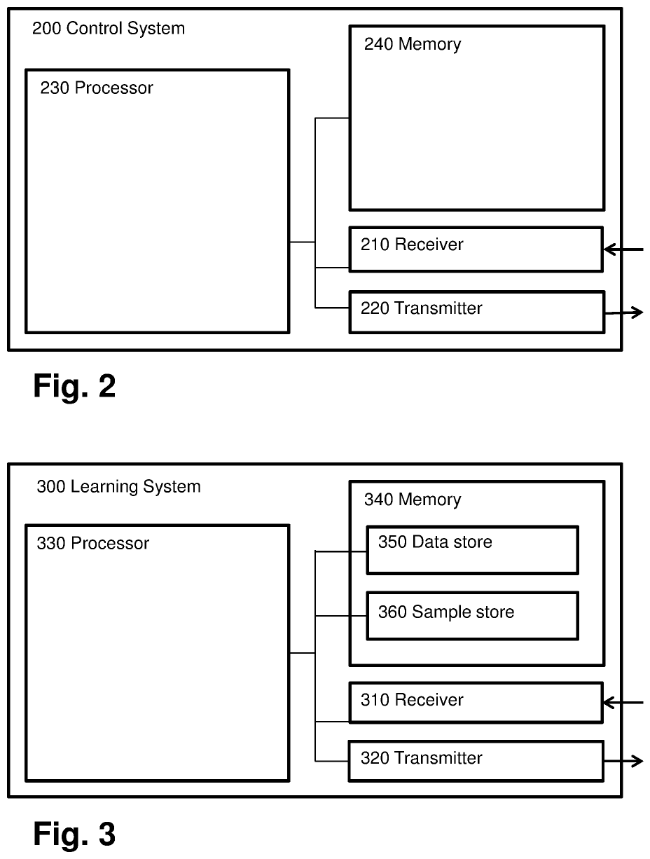

FIG. 2 shows a schematic representation of an example of the control system 200 shown in FIG. 1. The control system comprises a receiver 210 and a transmitter 220 for receiving and transmitting information from and to the external environment, for example to learning system 300 or vehicle 400. Control system 200 further comprises a processor 230 and a memory 240. The processor 230 may be configured to execute instructions stored in memory 240 for selecting power distributions. Transmitter 220 may be configured to transmit selected distributions to vehicle 400, so that this power distribution can be implemented at the vehicle 400.

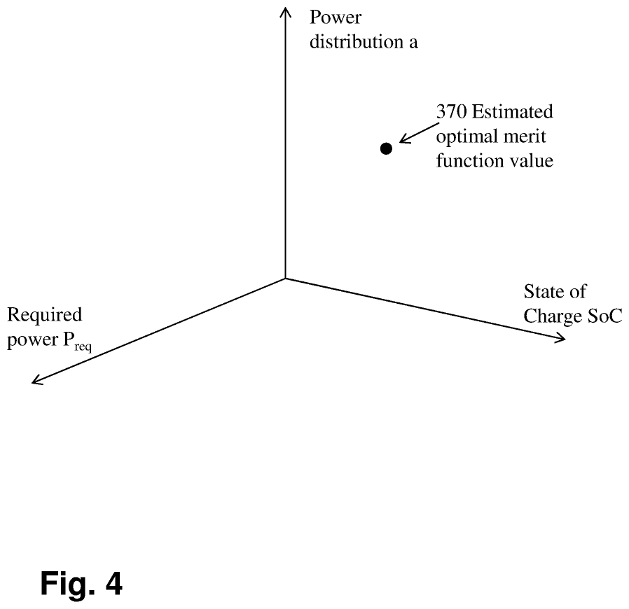

FIG. 3 shows a schematic representation of an example of the learning system 300 shown in FIG. 1. The learning system 300 comprises a receiver 310 and transmitter 320 for receiving and transmitting information from and to the external environment, for example to control system 200 or vehicle 400. Learning system 300 further comprises a processor 330 and a memory 340. The processor 330 may be configured to execute instructions stored in memory 340 for estimating merit function values. Memory 340 may comprise a data store 350 configured to store estimated merit function values. Memory 340 may further comprise a sample store 360 configured to store samples received from the vehicle 400. Each sample may comprise vehicle state data, power distribution data, and corresponding reward data at a particular point in time. When a sample is stored, it may be associated with a timestamp to indicate the time at which it was received from the vehicle 400.

Data store 350 may store a plurality of estimated merit function values. Each estimated merit function value may correspond to a particular vehicle state s, and a particular power distribution a. An estimated merit function value may represent the quality of a combination of a vehicle state and power distribution, that is to say, the estimated benefit of a choice of a particular distribution given the provided vehicle state. The vehicle state may comprise multiple data elements, wherein each data element represents a different vehicle state parameter. The estimated merit function values and corresponding vehicle state and distribution data may be stored in data store 350 in the form of a table, or in the form of a matrix. Vehicle state parameters may include, for example, the power required by the vehicle P_{req} at a moment in time. P_{req} may be specified by a throttle input to the vehicle. In implementations where one of the power sources is an electric motor powered by a battery, the vehicle state parameters may include the state of charge of the battery, SoC. The state of charge parameter represents the amount of energy (“charge”) remaining in the battery that can be used to supply motive power to the vehicle 400.

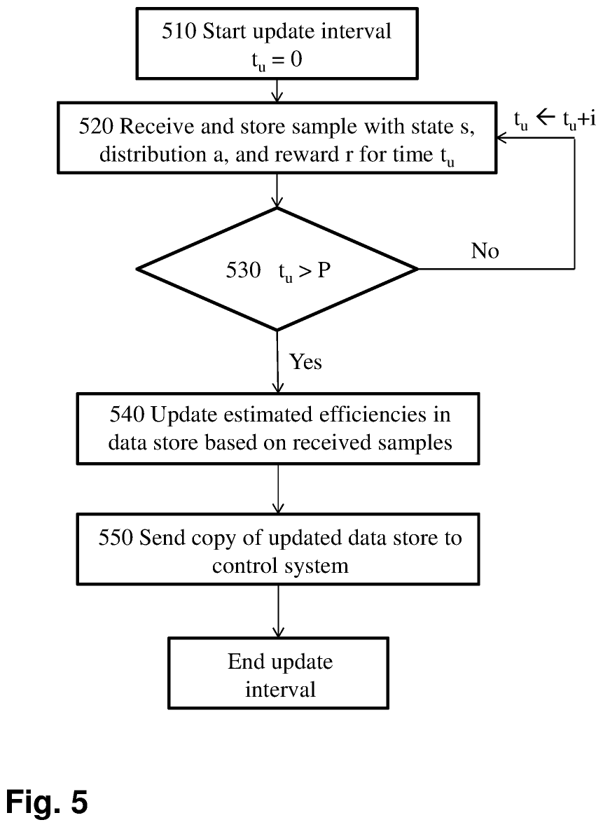

FIG. 4 illustrates an example of an estimated merit function value in the data store, in relation to corresponding vehicle state data. In the example of FIG. 4, the vehicle state data comprises two parameters: the power required by the vehicle Pre_{req}; and the state of charge SoC of the battery. The vehicle state parameters are represented by two axes in a graph. Power distributions between the first power source 410 and second power source 420 (indicated by the letter ‘a’) are represented by a third axis. For different vehicle state couples (Pre_{req}, SoC), merit function values are estimated for different possible power distributions a. For a particular vehicle state, the data store 350 can be used to look up estimated merit function values corresponding to different power distributions a. The power distribution with the highest merit function value, referred to herein as the estimated optimal merit function value 370, can be chosen as the optimal power distribution for that vehicle state. The estimations in data store 350 are determined by the learning system 300, and more detail on the methods and techniques used to obtain these estimations is provided later in this description.

As noted above, the vehicle power management system 100 comprises a control system 200 (such as that detailed in FIG. 2), and a learning system 300 (such as that detailed in FIG. 3). The control system 200 and learning system 300 may be collocated, that is to say, located in the same device, or on different devices in substantially close proximity of each other. For example, both of the control system 200 and learning system 300 may be physically integrated with the vehicle 400 the vehicle power management system 100 is configured to manage. In the case where the control system 200 and learning system 300 are located on the same device, connection 130 may be a connection or a network of interconnected elements within that device. In the case where the control system 200 and learning system 300 are on different devices which are in close proximity, the connection 130 may be a wired connection or close proximity wireless connection between the devices comprising the control 200 and learning 300 systems, respectively. The connection 130 may be implemented as one or more of a physical connection and a software-implemented connection. Examples of a physical connection include but are not limited to a wired data communication link (e.g. an electrical wire or an optical fibre), or a wireless data communication link (e.g. a Bluetooth™ or other radio frequency link). If learning system 300 and control system 200 are located on the same device, the processor 230 of the control system 200 and the processor 330 of the learning system 300 may be the same processor 230, 330. A processor may also be a cluster of processors working together to implement one or more tasks in series or in parallel. Alternatively, the control system processor 230 and learning system processor 330 may be separate processors both located within a single device.

Preferably, the vehicle power management system 100 is a distributed system, that is to say, the control system 200 and learning system 300 are implemented in different devices, which may be physically substantially separate. For example, the control system 200 may be located inside (or be otherwise physically integrated with) the vehicle 400, and the learning system 300 may be located outside (or be otherwise physically separate from) the vehicle 400. For example, the learning system 300 may be implemented as a cloud-based service. The connection 130 may be a wireless connection, for example, but not limited to, a wireless internet connection, or a wireless mobile data connection (e.g. 3G, 4G (LTE), IEEE 802.11), or a combination of multiple connections. An advantage of having the learning system 300 outside the vehicle is that the processor in the vehicle does not require the computing power needed to implement the learning steps of the algorithms executed by the learning system.

In embodiments where the control system 200 is located within the vehicle 400 and the learning system 300 is located outside of the vehicle 400, the receiver 110 of the vehicle power management system 100 may be substantially the same as the receiver 210 of the control system 200. The control system 200 may then transmit, using transmitter 220, samples received from the vehicle 400 to the receiver 310 of the learning system 300 over connection 130, to be stored in sample store 360. The vehicle power management system 100 manages the power distribution between the first power source 410 and the second power source 420 of a vehicle 400 in order to optimise the efficiency of the vehicle. The vehicle power management system 100 does this by determining which fraction of the total power required by the vehicle should be provided by the first power source and which fraction of the total power should be provided by the second power source. The power required by the vehicle is sometimes referred to as the required torque. When determining which power distribution is optimal, the vehicle power management system 100 may consider the current vehicle performance. The vehicle power management system 100 may also consider the long-term vehicle performance, that is to say, the performance at one or more moments or periods of time later than the current time.

The vehicle power management system 100 disclosed herein provides an intelligent power management system for determining which fractions of total required power are provided by the first 410 and second 420 power sources. The vehicle power management system 100 achieves this by implementing a method that learns, optimises, and controls a power distribution policy executed by the vehicle power management system 100. One or more of the steps of learning, optimising, and controlling may be implemented during real-world driving of the vehicle. One or more of the steps of learning, optimising, and controlling may be implemented continuously during use of the vehicle. The steps of optimising and learning a power distribution policy may be performed by the learning system 300. The step of controlling a power distribution based on that policy may be performed by the control system 200. The learning and optimising steps may be based on a plurality of samples, each sample comprising vehicle state data, vehicle power distribution data, and corresponding reward data. Each sample may be measured at a respective point in time.

Learning System

Samples may be measured periodically. The periodicity at which samples are measured is referred to as the sampling interval, i. Samples may be transmitted by the vehicle 400 to the vehicle power management system 100 as they are measured, or alternatively in a set containing multiple samples, at a set time interval containing multiple sampling intervals. The transmitted samples are stored by the vehicle power management system 100. The samples may be stored in sample store 360 of the learning system 300. The samples may be used by the learning system 300 to estimate merit function values to store in data store 350.

The learning system 300 is configured to update the estimated merit function values stored in the data store 350. This update may occur periodically, for example in each update interval, P. The frequency with at which updates are performed by the learning system 300 may be other than periodic, for example, based on the rate of change of one or more parameters of the vehicle 400 or vehicle power management system 100. An update may also be triggered by the occurrence of an event, for example the detection of one or more instances of poor vehicle performance. An update interval may have a duration lasting several sampling intervals, i. The samples falling within a single update interval form an update set. The number of sampling intervals included within an update set is referred to as the update set size. The learning system 300 bases the update on a plurality of samples, wherein the number of samples forming that plurality may be the update set size, and wherein the plurality of samples are the update set. An advantage of using a plurality of samples measured at different points in time is that the estimation takes into account both current and long-term effects of the power distributions on vehicle performance when estimating merit function values.

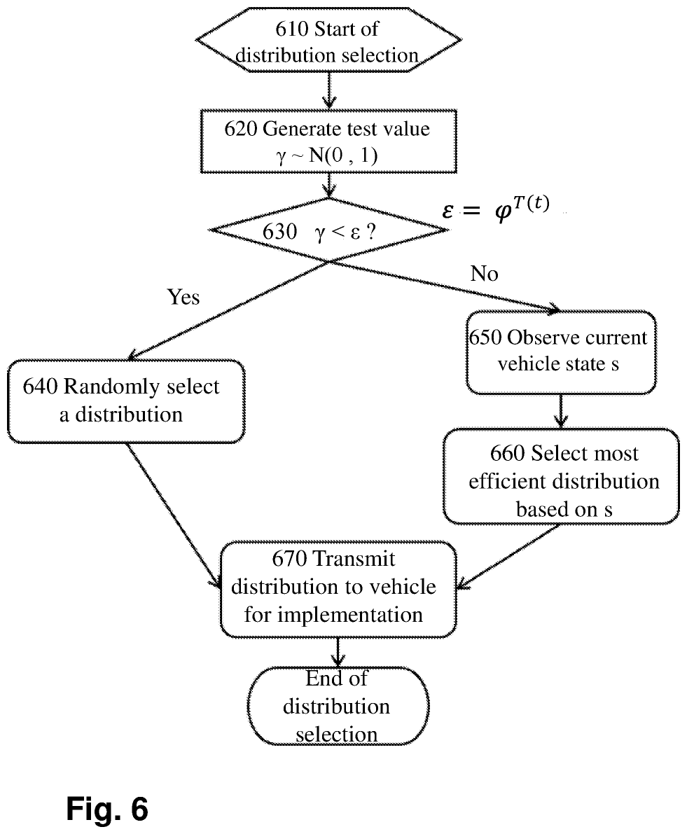

FIG. 5 shows a flowchart of an update interval iteration. In step 510 the update interval time counter tᵤ is set to zero. In step 520 the vehicle power management system 100 receives a sample from vehicle 400. The sample may comprise vehicle state data s, distribution data a, and corresponding reward data r, at a specified time. The performance of a vehicle may be expressed as a reward parameter. The reward data r may be provided by the vehicle in the form of a reward value. Alternatively, the vehicle may provide reward data from which the reward can be determined by the vehicle power management system 100, by either or both of the control system 200 and learning system 300. The sample is added to the update set, and may be stored in sample store 360. In step 530 interval time counter tᵤ is compared to update interval P. If tᵤ is smaller than P, a sample interval i passes, and step 520 is repeated so that more samples may be added to the update set. If at step 530 tᵤ is found to be greater than update interval P, the sample collection for this update interval stops, and the sample set is complete. The time period covered by the update set may be referred to as the predictive horizon. The predictive horizon indicates the total duration of time taken into account by the process for updating the estimations of merit function values in the data store 350. In step 540 the learning system 300 updates the estimated merit function values in data store 350. The estimation is based on the plurality of samples in the update set. The samples on which the update of the estimated merit function values is based all occurred on times falling in the update interval immediately preceding the update time, and cover a period of time equal to the predictive horizon. The algorithms used by the learning system to estimate the merit function values used to update the data store 350 are described in more detail below. Once the data store 350 is updated, the learning system may send a copy of the updated data store 350 to the control system 200. The update interval iteration ends. The sample provided after the last sample that was included in the previous update set is used to form a new update set. It is possible that a new update set sample collection starts before the previous update to the merit function values is completed.

The control system 200 uses the estimated merit function values of data store 350 to select a power distribution between the first power source 410 and second power source 420, and to control the power distribution at the vehicle by transmitting the selected power distribution to the vehicle. The selected power distribution is then implemented by the vehicle 400, that is to say, the control system 200 causes the first power source 410 and the second power source 420 to provide motive power to the vehicle in accordance with the selected power distribution. The control system 200 may access data store 350 using connection 130 between the control system 200 and learning system 300. Alternatively, the control system 200 may comprise an up-to-date copy of the data store 350 in its memory 240. This copy of the data store 350 allows the control system 200 to function individually without being connected to the learning system 300. In order to keep the copy of the data store 350 up to date, the learning system may transmit a copy of the data store 350 to the control system 200 following an update. Alternatively and/or additionally, the control system can request an updated copy from the learning system, at predetermined times, or by other events triggering a request.

Control System

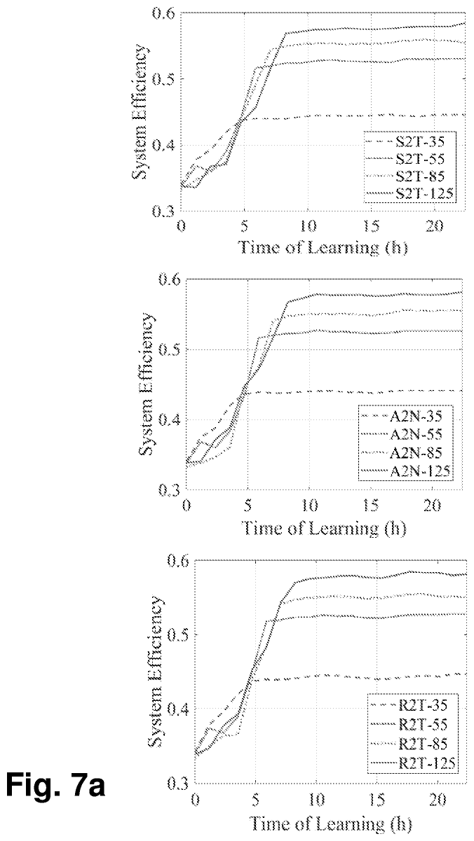

FIG. 6 illustrates the steps in a method for selecting a power distribution. The method may be regarded as an implementation of the so-called “epsilon-greedy” algorithm. A power distribution is selected by the control system at different points in time. The time between distributions is the selection interval. At step 610 the control system 200 starts a new distribution selection iteration at time t, the current time for that iteration. In step 620 the control system generates a test value, yγ, wherein γ is a real number with a value between 0 and 1 randomly generated using a normal distribution N(0,1). The random generation may be a pseudo-random generation. In the next step 630 the test value is compared to a threshold value. The threshold value ε is a value determined by the control system 200. It is a real number with a value between 0 and 1. The threshold value ε may decrease with time, for example as part of the function ε=φ^{T(t)} , wherein φ is a real number between 0 and 1, and t represents the time of learning. This value t may be the total time of learning. T(t) may be a function of the total time of learning t, used to decrease the value of ε, as total time of learning t increases. The value of φ may be a constant between 0.9 and 1, but not including 1. The threshold value ε may gradually decrease from φ, to approach 0 over time, according to a function other than ε=φ^{T(t)} , for example ε may decrease as a linear, quadratic, or logarithmic function of total time of learning t. If the test value γ is smaller than the threshold value c, at step 640 the control system 200 selects a distribution by randomly selecting a distribution from all possible distributions. If the test value γ is equal to or greater than the threshold value ε, the method proceeds to step 650 in which it observes the current vehicle state, s. Observing the vehicle state may include receiving, at receiver 210, from the vehicle 400, vehicle state data of the vehicle 400 at the current time t. The vehicle state data may be sent by the vehicle 400 in response to a request from the control system 200. In step 660 of the method the control system is configured to select, from the data store 350, or the local copy of data store 350, the optimal distribution of power between the first power source 410 and second power source 420. The control system 200 determines the optimal distribution by going into the data store and finding the distributions corresponding to the current, given, vehicle state, determining which distribution has the highest corresponding estimated merit function value in the data store 350, and selecting the distribution corresponding to that highest merit function value.

Following on from step 640 or 660, in step 670 the control system 200 uses transmitter 220 to transmit the distribution to be implemented at vehicle 400. In some embodiments, the control system 200 may be at least partially integrated into the vehicle 400, that is to say, it is able to manage parts of the vehicle 400 directly. In such embodiments, the control system 200 transmits the selected distribution to the part of the control system 200 managing parts of the vehicle 400, and sets the power distribution to be the selected distribution at current time t. The control system finishes the current distribution selection process, and starts a new distribution selection at the time of the start of the next selection interval. The duration of a selection interval determines how often the power distribution can be updated. The control system requires enough computing power to finalise a distribution selection iteration within a single selection interval. If the control system 200 takes longer than a selection interval to complete a single distribution selection iteration, the selection interval duration should be increased. A selection interval duration may be, for example, 1 second, or any value between and including 0.1 second and 15 seconds.

An advantage of the control system 200 using the epsilon-greedy algorithm, as described above, is that it allows distributions to be entered which would not otherwise be selected based on the merit function values obtained from the data store 350. This allows the learning system 300 to populate the merit function values stored in data store 350 by reaching values that would not otherwise be reached. The occasional random selection of power distributions means that over a sufficiently long period of time, or all possible power distributions will be implemented for all possible vehicle states. The epsilon-greedy algorithm provides samples for all vehicle states and distributions to the learning system 300, used to populate the data store 350.

An advantage of having the threshold value ε reduce over time is that selecting a random distribution becomes less likely as more time passes. This means that, as the data store 350 fills up with merit function values, the estimations become more reliable as more different situations have been taken into account to update the data store merit function values, and the occurrences of random selections decrease. This has a positive effect on vehicle performance, as distribution selection based on estimations leads to better efficiency of the vehicle than random distribution selection.

Learning Algorithms

The learning system 300 herein disclosed preferably uses reinforcement learning algorithms to estimate merit function values. The reinforcement learning algorithm may be an n-step reinforcement learning algorithm. It is based on measured data provided through use of the vehicle, for example real-world use of the vehicle, and does not make use of simulated data or other models as a starting point. The starting point for the learning system 300 is an empty data store, wherein none of the merit function values have been determined. When there is no estimated merit function value for an observed vehicle state, the control system 200 can access a fall-back control policy stored in memory 240. The fall-back control policy may be determined during the research and development of the vehicle, and stored in memory 240 when the vehicle is manufactured. The vehicle power management system 100 collects a time series of samples at a rate corresponding to the sampling interval. Each sample comprises data relating to vehicle state s, e.g. required power P_{req} and state of the first power source SoC, power distribution a, and resulting reward r. The reward relates to the performance of the vehicle as a result of the selected power distribution and vehicle state at that time, and may be linked to for example fuel consumption of an internal combustion engine, and/or state of charge of a battery. A plurality of samples, forming an update set, is used by the learning system 300 to calculate estimated merit function values using a multiple-step reinforcement learning algorithm. The multiple-step reinforcement learning algorithm optimises the vehicle performance over a predictive horizon, that is to say, the estimation of the optimal distribution is not based only on the current state, but also takes into account effects of the choice of distribution on future states of the vehicle. An advantage of reinforcement learning as set out herein is that it does not use predicted, or otherwise potentially incorrect values, for example from predictive models, or databases containing data from other vehicles. The reinforcement learning algorithms and methods described in the application are based on measured vehicle parameters representing vehicle performance. As a result, the model-free method of reinforcement learning disclosed herein can achieve higher overall optimal efficiencies.

An advantage of basing a learning algorithm for optimising vehicle performance on real-world driving, as set out herein, is that the algorithm can adapt to the driving style of an individual driver and/or the requirements of an individual vehicle. For example, different drivers may have different driving styles, and different vehicles may be used for different purposes, e.g. short distances or long distances, and/or in different environments, e.g. in a busy urban environment or on quiet roads. Within a single vehicle, different users may have different driving styles, and the vehicle power management system 100 may comprise different user accounts, wherein each user account is linked to a user. Each user account may have a separate set of estimated merit function values stored in a data store linked to that user account, and wherein the estimations are based on samples obtained from real-world use of the vehicle by the user of that account.

In the following paragraphs, three different example algorithms will be described which can be used to estimate merit function values of power distributions between a first power source 410 and a second power source 420. All three of the algorithms iteratively(and, optionally, periodically) update estimated merit function values based on a set of samples, referred to as the update set. The amount of samples in the update set, the update set size, can be represented as ‘n’. The samples span a time interval equal to the predictive horizon, with the earliest sample taken at time t, the following samples taken at sampling intervals i, so t+i, t+2i, . . . up until the last sample taken at time at t+(n-1)i=t+p. Viewed from the perspective of the earliest sample, the times at which the later samples are taken occur in the future. Starting from the earliest sample, the algorithms may be referred to as “predictive” because they use future sample values, even though all samples were obtained at a time in the past and no actual predictive values are used to estimate the merit function values.

The algorithms set out below relate to determining merit function values, namely the efficiency of the performance of vehicle 400 as a result of the selected power distribution given the vehicle state at the time. In some embodiments, optimising efficiency of the vehicle may be defined as minimising power loss Pₗₒₛₛ in the vehicle while simultaneously maintaining as much as possible the state of charge SoC of a battery. The power loss in a vehicle may be expressed as the sum of power loss in the first power source 410 and the power loss in the second power source 420. An example measure of maintaining SoC level at all times t, is to require that the level of charge remaining in the battery SoC remains above a reference level SoC_{ref}. An example SoC_{ref} value is 30%, or any value between and including 20% and 35%. In the case where one of the power sources, for example the first power source 410, is an electric motor receiving power of a battery, the second power source 420, which may be an internal combustion engine, may provide charge to the battery of the power source. Therefore, it is possible for the state of charge to be kept above, or be brought above, a reference level of charge. In an example functionality of distribution control, if the state of charge of a battery falls below the reference level, the use of the power source drawing power from this battery may be decreased, so that the battery can recharge to a level above the reference level of charge.

A merit function value estimation calculation is in part based on a reward r, a value representing the performance of the vehicle as a result of a distribution used in combination with a particular vehicle state. The value of reward r is based on data obtained by the vehicle 400, wherein a reward at time t is expressed as r(t). The vehicle may provide the value of reward r to the vehicle power management system, or it may provide data from which the value of reward r can be determined. The reward r corresponding to a selected distribution and related vehicle state may be calculated by taking initial value rᵢₙᵢ and reducing by the amount of lost power Pₗₒₛₛ, and taking into account the SoC levels, using the following equation:

$$r ( t ) = \{ \begin{matrix}{r}_{ini} - {P}_{loss} ( t ) & S o C ( t ) \geq S o {C}_{ref} \\ {r}_{ini} - {P}_{loss} ( t ) - k \vert So {C}_{ref} - S o C ( t ) \vert & S o C ( t ) < S o {C}_{ref}\end{matrix}$$

In the above equation, k is a scale factor to balance the consideration of the SoC level and the power loss. The SoC level reduces the value of reward r when it falls below the reference value, and the amount by which the reward is reduced increases as the state of charge level of the battery drops further below the reference value. The Pₗₒₛₛ is a penalty value applied to the reward of the corresponding vehicle state and selected distribution. If the distribution of power between the first and second sources is set so that the amount of power lost is reduced, the resulting reward will be higher. The reward r may be dimensionless.

A first algorithm to estimate merit function values of power distributions between a first power source 410 and a second power source 420 is a sum-to-terminal algorithm (S2T), which bridges the current action at time t to a terminal reward provided by a distribution at time t+p. Taking Q(s(t),a(t)) as the estimated merit function value for vehicle state s and distribution a in data store 350, the S2T algorithm uses the set of n samples taken at times t, t+i, t+2i, . . . , t+(n-1)i and calculates:

Q_{update}(s(t), α(t))=Q(s(t), α(t))+α[Q^{max}(s(t+(n−1)i),:)−Q(s(t), α(t))+Σₖ₌₀ⁿ⁻¹r(t+ki)]

In this notation Q_{update}(s(t), α(t)) is the updated merit function value for vehicle state s and distribution a. In this notation, Q_{update} may replace the old Q value once the update has been completed. Q may be considered as a merit function, providing a merit function value for a given vehicle state s and power distribution a. The updated merit function value is calculated by taking Q^{max}(s(t+(n−1)i), :), which is the highest known merit function value chosen for the vehicle state of the sample taken at time s+(n−1)i, for any distribution. This maximum value is reduced by the current merit function value for state s and distribution a, and the updated value is increased with the value of the sum of the values of the rewards of the samples in the update set. α is the learning rate of the algorithm, with a value 0 <α≤1. The learning rate a determines to what extent samples in the update set influence the information already present in Q(s(t), a(t)). A learning rate equal to zero would make the update learn nothing from the samples, as the terms in the update algorithm comprising new samples would be set to equal zero.

Therefore, a non-zero learning rate α is required. A learning rate α equal to one would make the algorithm only consider knowledge from the new samples, as the two terms of +Q(s(t),α(t)) and −αQ(s(t),α(t)) in the algorithm cancel each other out when α equals 1. In a fully deterministic learning environment, a learning rate equal to 1 may be an optimal choice. In a stochastic learning environment, a learning rate α of less than 1 may result in a more optimal result. An example choice for a for the algorithm is α=;0.5. The above comments apply regarding learning rate a also apply for the A2N and R2T algorithms described below.

A second algorithm to estimate merit function values is the Average-to-Neighbour algorithm (A2N). The A2N algorithm uses the relationship of a sample with a neighbouring sample in the time series of the update set. Using a similar notation as set out above, the equation for estimating merit function values is:

$${Q}_{update} ( s ( t ) , a ( t ) ) = Q ( s ( t ) , a ( t ) ) + α [ {Q}^{max} ( s ( t + i ) , : ) - Q ( s ( t ) , a ( t ) ) + \frac{1}{n} {\sum }_{k = 0}^{n - 1} r ( t + k i ) ]$$

In the A2N algorithm, the updated merit function values are determined based on the arithmetic mean, or average, of the rewards of the samples in the update set.

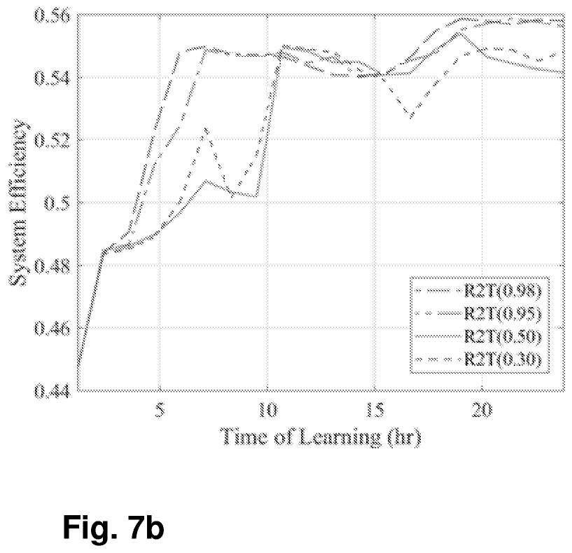

A third algorithm to estimate merit function values of power distributions between a first power source 410 and a second power source 420 is a recurrent-to-terminal (R2T) algorithm. This is a recursive algorithm, wherein the rewards for each sample, as well as difference between the highest known merit function value and the estimated merit function value for each sample in the time series is taken into account. A weighted discount factor λ is applied to the equation, wherein λ is a real number with a value between 0 and 1. For a weighted discount factor less than 1 but greater than 0, the samples measured a later point in time are allocated a greater weight. For a discount factor λ equal to 1, the weight is equal for every sample. The value of the discount factor may influence the performance of the algorithm. A higher value of λ results in a better optimal merit function value as learning time increases, as well as a faster learning time, as illustrated in FIG. 7b. FIG. 7b shows the system efficiency, that it to say, the vehicle power efficiency of power conversion, for different values of λ, and as a function of learning time. An example value for discount factor λ is 1.00. Other example values for discount factor λ, illustrated in FIG. 7b, are 0.30, 0.50, 0.95, and 0.98.

The equation for updating estimated merit function values, using similar notation as for the first and second algorithms, is:

$${Q}_{update} ( s ( t ) , a ( t ) ) = Q ( s ( t ) , a ( t ) ) + α [ {\sum }_{k = 0}^{n - 1} {λ}^{n - k} r ( t + ki ) + {\sum }_{k = 1}^{n} ( {λ}^{n - k + 1} {Q}^{max} ( s ( t + k i ) , : ) - Q ( s ( t + ( k - 1 ) i ) , a ( t + ( k - 1 ) i ) ) ) ]$$

The number of samples n in an update set, used to update the estimated merit function values, has an effect on the performance of the three algorithms described above, as illustrated in FIG. 7a. In FIG. 7a, the system efficiency shown on the y-axis of the graphs represents a vehicle efficiency of power conversion as a result of using the vehicle power management system, and as a function learning time. The resulting vehicle system efficiency is shown for the S2T, A2N, and R2T algorithms, and for update sets including 35, 55, 85, and 125 samples. An advantage of including a greater amount of samples in an update iteration, that is to say, increasing update set size n, can lead to a higher optimal estimated merit function values, leading to better overall vehicle performance. However, increasing update set size n requires a longer real-world learning time to find these optimal merit function values.

The above paragraphs have described a hybrid vehicle with first and second power sources. The same methods as described above also apply to hybrid vehicles with more than two power sources.

It will be appreciated by the person skilled in the art that various modifications may be made to the above described embodiments, without departing from the scope of the invention as defined in the appended claims. Features described in relation to various embodiments described above may be combined to form embodiments also covered in the scope of the invention.

1. A vehicle power management system for optimising power efficiency in a vehicle comprising a first power source and a second power source, by managing a power distribution between the first power source and second power source, the vehicle power management system comprising:
a receiver configured to receive a plurality of samples from the vehicle, each sample comprising vehicle state data, a power distribution and reward data measured at a respective point in time;
a data store configured to store estimated merit function values for a plurality of power distributions;
a control system configured to
select, from the data store, a power distribution having the highest merit function value for the vehicle state data at a current time, and
transmit the selected power distribution to be implemented at the vehicle; and
a learning system configured to update the estimated merit function values in the data store, based on the plurality of samples, each measured at a different point in time.

2. The vehicle power management system of claim 1, wherein the vehicle state data comprises required power for the vehicle.

3. The vehicle power management system of claim 1, wherein the first power source is an electric motor configured to receive power from a battery.

4. The vehicle power management system of claim 3, wherein the vehicle state data further comprises state of charge data of the battery.

5. The vehicle power management system of claim 1, wherein the learning system is configured to update the estimated merit function values in the data store based on samples taken during the time period between the current update and the most recent preceding update.

6. The vehicle power management system of claim 1, wherein the learning system and the control system are separated on different machines.

7. The vehicle power management system of claim 1, wherein the learning system is configured to update the estimated merit function values in the data store using a predictive recursive algorithm.

8. The vehicle power management system of claim 1, wherein the learning system is configured to update the estimated merit function values in the data store according to a recurrent-to-terminal (R2T) algorithm.

9. The vehicle power management system of claim 1, wherein the control system is configured to:
generate a random real number between 0 and 1;
compare the randomly generated number to a pre-determined threshold value; and
if the random number is smaller than the threshold value, generate a random power distribution; or
if the random number is equal to or greater than the threshold value, select, from the data store, a power distribution having the highest merit function value for the vehicle state data at a current time.

10. A method for optimising power efficiency in a vehicle comprising a first power source and a second power source, by managing a power distribution between the first power source and the second power source, the method comprising:
receiving, by a receiver, a plurality of samples from a vehicle, each sample comprising vehicle state data, a power distribution and reward data measured at a respective point in time;
storing, in a data store, estimated merit function values for a plurality of power distributions;
selecting, by a control system, a power distribution from the data store having the highest merit function value for the vehicle state data at a current time; and
updating, by a learning system, the estimated merit function values in the data store, based on the plurality of samples, each measured at a different point in time.

11. The method of claim 10, wherein the vehicle state data comprises required power for the vehicle.

12. The method of claims 10, wherein the first power source is an electric motor receiving power from a battery.

13. The method of claim 12, wherein the vehicle state data further comprises state of charge data of the battery.

14. The method of claims 10, wherein the learning system updates the estimated merit function values based on samples taken during the time period between the current update and the most recent preceding update.

15. The method of claims 10, wherein the method steps performed by the learning system are performed on a different machine to the method steps performed by the control system.

16. The method of claims 10, wherein updating the estimated merit function values, by the learning system, comprises updating the estimated merit function values using a predictive recursive algorithm.

17. The method of claims 10, wherein the method further comprises updating, by the learning system, the estimated merit function values in the data store according to a recurrent-to-terminal (R2T) algorithm.

18. The method of claims 10, further comprising
generating, by the control system, a real number between 0 and 1;
comparing the randomly generated number to a pre-determined threshold value; and
if the random number is smaller than the pre-determined threshold value, generating, by the control system a random power distribution; or
if the random number is equal to or greater than the threshold value, select, by the control system, from the data store, a power distribution having the highest merit function value for the vehicle state data at a current time.

19. A processor-readable medium storing instructions that, when executed by a computer, cause the computer to perform a method for optimising power efficiency in a vehicle comprising a first power source and a second power source, the method comprising:
receiving, by a receiver, a plurality of samples from a vehicle, each sample comprising vehicle state data, a power distribution between the first power source and the second power source, and reward data measured at a respective point in time;
storing, in a data store, estimated merit function values for a plurality of power distributions;
selecting, by a control system, a power distribution from the data store having the highest merit function value for the vehicle state data at a current time; and
updating, by a learning system, the estimated merit function values in the data store, based on the plurality of samples, each measured at a different point in time.
